(19) United States
(12) Patent Application Publication
(10) Pub. No.: US 2026/0086839 A1
(43) Pub. Date: Mar. 26, 2026

(54) Isolated Software Package

(71) Applicants: Matthew R. Semich, Fredericksburg, VA (US); Ian Patrick O'Malley, Fredericksburg, VA (US)

(72) Inventors: Matthew R. Semich, Fredericksburg, VA (US); Ian Patrick O'Malley, Fredericksburg, VA (US)

(73) Assignee: United States of America, as represented by the Secretary of the Navy, Arlington, VA (US)

(21) Appl. No.: 18/896,990

(22) Filed: Sep. 26, 2024

(51) Int. Cl. G06F 9/455; G06F 9/445

(52) U.S. Cl. CPC G06F 9/45558; G06F 9/44505; G06F 2009/45587; G06F 2009/45591

(57) ABSTRACT

A computer-implemented operation method is provided for isolating a software application from operating system software, including: installing a configuration file; installing a plurality of detectors; and installing and executing a monitoring software program. The configuration file enables interaction with the application. The detectors analyze input to the application. The input either belongs to an authorization list or else is absent therefrom. Executing the monitoring software program loads the detectors, receives application information from the configuration file, and activates an alert in response to the input being absent from said authorization list.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to software. In particular, software protection from interference during execution within a host operating system.

### SUMMARY

Conventional software protection yield disadvantages addressed by various exemplary embodiments of the present invention. In particular, various exemplary embodiments provide a technique for isolating a software application from operating system software, including: installing a configuration file; installing a plurality of detectors; and installing and executing a monitoring software program.

The configuration file prescribes the expected interactions with the application. The detectors analyze input to the application. The input either belongs to an authorization list or is absent therefrom. Executing the monitoring software program loads the detectors, receives application information from the configuration file, and initiates an action in response to the input being absent from said authorization list. Such action can for example, be an alert.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of a host platform with protection software for an application;

FIGS. 2A and 2B are block diagram views of the host and/or application including intrusion detection;

FIG. 3 is a block diagram view of the protection software;

FIGS. 4A and 4B are code instruction views of detectors and actions;

FIG. 5 is a block diagram view of the protection software with the host in operation;

FIG. 6 is a code instruction view of a java command;

FIG. 7 is a code instruction view of a test mount;

FIG. 8 is a logic flow diagram view of a mount process;

FIG. 9 is a code instruction view of variable labeling;

FIG. 10 is a logic flow diagram view of an environment process;

FIG. 11 is a code instruction view of an expected process;

FIG. 12 is a logic flow diagram view of user and process identification;

FIG. 13 is a code instruction view of for an expected port access;

FIG. 14 is a logic flow diagram view of communication sockets;

FIG. 15 is a block diagram view of a host and a virtual machine with main and logging containers;

FIG. 16 is a block diagram view of the host and virtual machine with an additional security container;

FIG. 17 is a block diagram view of the host and virtual machine under alert;

FIG. 18 is a block diagram view of the virtual machine under query;

FIG. 19 is a block diagram view of the virtual machine under event;

FIG. 20 is a block diagram view of the virtual machine with the main container under transform;

FIG. 21 is a block diagram view of the virtual machine with removal of the security container;

FIG. 22 is a block diagram view of the virtual machine in transformation;

FIG. 23 is a block diagram view of BlackBox software in communication with detectors, actions and files;

FIG. 24 is a block diagram view of the virtual machine with BlackBox software;

FIG. 25 is a block diagram view of the virtual machine under alert; and

FIG. 26 is a block diagram view of the virtual machine and host with Docker;

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

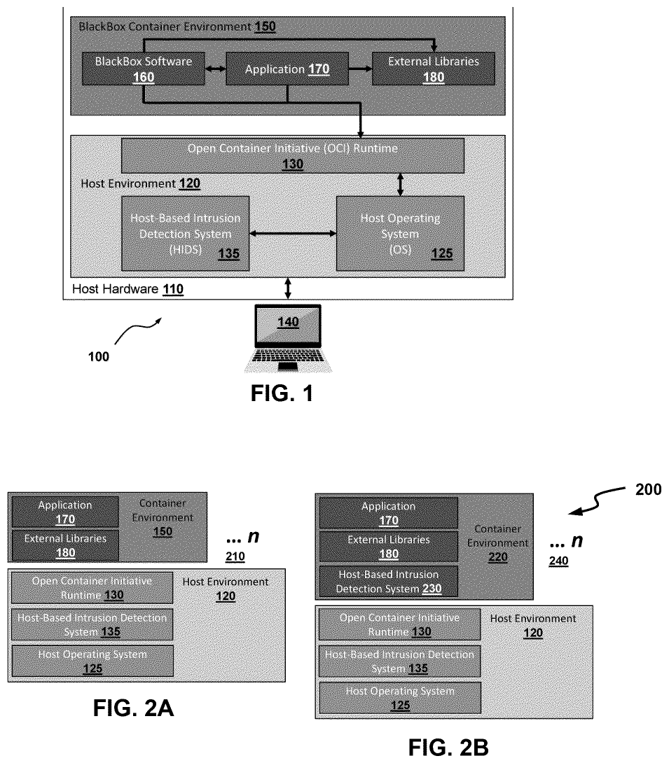

FIG. 1 shows a block diagram view 100 of an exemplary computer system showing BlackBox execution. A host computer platform 110 maintains a host environment 120 that includes operating software (OS) 125, OCI runtime 130 and host-based intrusion detection system (HIDS) 135. The OS 125 can be stored on Read-Only Memory (ROM) for tasking on Random Access Memory (RAM).

The OS 125 interacts with its Host-based Intrusion Detection System (HIDS) 135, which receives input from an exemplary BlackBox container environment 150 that hosts BlackBox software 160 and insulated application software 170. Both the BlackBox software 160 and the application 170 interacts with stored libraries 180 to facilitate functionality.

The container environment 150 relies on the host system 110 to provide the OS 125, and the container hosts the supporting libraries 160 needed to execute the application. This exemplary configuration enables an application 170 to be executed anywhere that incorporates an OCI-compliant runtime 130. An issue arises when the developer of the container environment 150 does not control the deployment platform as the system 110 that implements host protections to prevent someone attaching to, altering the behavior of, or executing unexpected processes within the container. Open Container Initiative (OCI) software offers a technique to package all necessary libraries 160 into an executable program that can be easily transported between platforms.

BlackBox software 160 was developed to be a minimal, modular, Host-Based Intrusion Detection System (HIDS) 135. The BlackBox software 160 implements Zero Trust strategies inside the container environment 150 to ensure the software being deployed operates as intended without interference. This implementation does not fully protect the contents of the container environment 150, because an operator can still extract the contents at rest, but provides assurance tools to regulate the expected behavior of the container environment 150 when executing an application 170.

Established in 2015 by Docker, OCI constitutes an open governance structure to create open industry standards around container formats and runtimes. OCI includes specifications for Runtime to execute a file-system bundle, Image and Distribution. Zero Trust architecture for perimeter-less security offers an approach to information technology design and implementation.

This security model implements a “never trust, always verify” protocol, such that operators and devices should not have access by default, even when connected to a sanctioned network, even when previously verified and permitted. BlackBox software 160 includes “detectors” and “actions”, and the configuration file prescribes the expected interactions with the application as to be described further.

FIGS. 2A and 2B are block diagram views 200 of host-based intrusion detection. FIG. 2A illustrates a conventional host environment 120 where the software monitoring is in the host platform 110, not the container environment 150. Containers are protected from intrusions at the host level but lack the ability to ensure that they are running properly. The host environment 120 can include an n plurality 210 of such container environments 150 with applications 160 and libraries 180.

FIG. 2B illustrates the exemplary BlackBox HIDS container environment 220 including an internal HIDS 230 within the Open Container Initiative Container. The host environment 120 can include an n plurality 240 of container environments 220. Having the auxiliary HIDS module 230 inside the container environment 150 does not ensure protection of the host platform 110. Thus, hardware HIDS module 135 should nonetheless be implemented in the host environment 120 on the host platform 110. This methodology permits the developer of the container environment 150 to implement custom protections without requiring the host platform 110 to determine what must be configured to protect the container at runtime 130.

Open Container Initiative (OCI) Containers offer a technique to package all the necessary libraries 180 into an executable that can easily be transported between platforms. The container environment 150 relies on the host environment 120 to provide the operating system (OS) 125, and the container environment 150 includes the external libraries 180 needed to execute the application 170. This enables an application 170 to be executed anywhere that incorporates an OCI-compliant runtime 130. An issue arises when the developer of the container environment 150 does not control the host environment 120 that implements the HIDS 230 to prevent someone attaching to, altering the behavior of, or executing unexpected processes within the container environment 150.

There are HIDS modules 135 and 230 that monitor events ranging from network traffic to system logs for abnormalities. These systems are executed on a host system 110 that provides an OCI compliant runtime 230. Container environments 150 are designed with a minimal set of dependencies, which means they are not designed to have an Intrusion Detection System (IDS). Efforts have been conducted to ensure that the container image is protected at rest, nothing has been done to protect the container environment 150 at runtime. Various researched methods of implementing protection is listed as follows.
(a) File Access Policy Daemon (fapolicyd) is a Red Hat application that ensures only trusted applications 170 are running on the host environment 120. This daemon queries the trust database for installed software such that in the event an application not in the trust database has been installed, fapolicyd prevents the application 170 from running. This implementation requires that the container 150 have fapolicyd, dnf, and systemd installed inside the container environment 150, which increases the attack surface area. One particular limitation is that fapolicyd confirms that the applications running are approved but does not verify they are running as expected or determine whether the environment in which they are running has changed.
(b) Snort is an open source IDS provided by Cisco Systems in San Jose, California that enables the operator to specify rulesets to monitor network traffic. This IDS transforms each data packet and runs rules on the data to determine whether the packet matches a rule or not. In the event the packet violates a rule, Snort produces an alert. This IDS has the limitation of only monitoring network traffic, and not all the interactions with a container environment 150. The software is also meant to be installed on a host platform 110 that has containers 210 and 240. However, the monitoring and sanitizing happen before the network traffic is relayed to the container environment 150.
(c) Open Source Security (OSSEC) is an open source HIDS 135 that monitors logs and the file system and enforces security policies. OSSEC is commonly used strictly as a log analysis tool for monitoring and analyzing firewalls, IDSs, web servers, and authentication logs. The software is to be installed on the host 110 that provides the OCI runtime 230 for containers 150.
(d) Security-Enhanced Linux (SE Linux) is software in the Linux kernel that enforces mandatory access control policies. SE Linux is set up on the host system and not within the container 150. SE Linux can be set up to perform similar detections. However, the protections are at the host level and not within the container 150 being delivered.
(e) Tools have been developed that protect the container image and ensure it has not been tampered with. However, they focus on protecting a container 150 at rest, not a running container 150. These tools employ hashing of the image and encryption of the image manifest to ensure that the image has not been tampered with. An example of this is Dockers Notary, which signs container images so that one can set up the host 110 to only use images that are signed. This ensures only trusted containers 150 run.
(f) Falco is a cloud native runtime security tool for Linux operating systems. Falco is designed to detect and alert on abnormal behavior and potential security threats in real-time. At its core, Falco is a kernel monitoring and detection agent that observes events, such as syscalls, based on custom rules. Falco can enhance these events by integrating metadata from the container runtime 130 and Kubernetes. The collected events can be analyzed off-host in SIEM or data lake systems (falco.org/docs).
(g) Microsoft Defender for Containers is a cloud-native solution to improve, monitor, and maintain the security of one's containerized environments 150, and their applications 170, across multicloud and on-premises environments. Similarly to Falco, the defender agent collects signals from host environments 120 using eBPF technology, and provides container runtime 130 protection (learn.microsoft.com/en-us/azure/defender-for-cloud/defender-for-containers-introduction). Most, if not all, of the major cloud providers offer a similar set of security tools. All of them are intended to protect the hosted services themselves from external actors, and to mitigate the risk of and impact of malicious containers 150 escaping their sandbox or exceeding their privileges.
(h) Apptainer—an open-source fork of Singulartiy—is a container environment 210 that focuses on high performance computing (HPC) environments. Using a custom image format and container runtime 130, Apptainer supports cryptographic signature verification and in-memory decryption of encrypted images; however, the focus on HPC results in containers 150 being less isolated from each other and the host 110 than other security platforms.
(i) An application kernel gVisor provides a virtualized environment in order to sandbox containers. The system interfaces normally implemented by the kernel of the host 110 are moved into a distinct, per-sandbox application kernel in order to minimize the risk of a container escape exploit. In particular, gVisor is an application kernel that implements a substantial portion of the Linux system surface, including an Open Container Initiative (OCI) runtime 130 called runsc that provides an isolation boundary between the application 170 and the kernel (github.com/google/gvisor) of the host 110. The objective is to protect the host 110 from malicious actors escaping from vulnerable containers 150. Use of gVisor requires installation of software and configurations on the host environment 120.

The BlackBox software 160 is designed to monitor events within an OCI container 150. There is a set of trusted values for a container environment 150 that is provided to the BlackBox software 160 via a configuration file 340. The detectors 335 check against the trusted values and monitor the events within the container 150 to confirm what is happening is permitted. For detection of an unexpected event, the software reports the unexpected behavior. The BlackBox software 160 monitors the following interactions within the variables in the container: environment 150, mounting a file system or device, changing the operator within the container environment 150, unexpected listening ports within the container environment 150, and unexpected processes being executed.

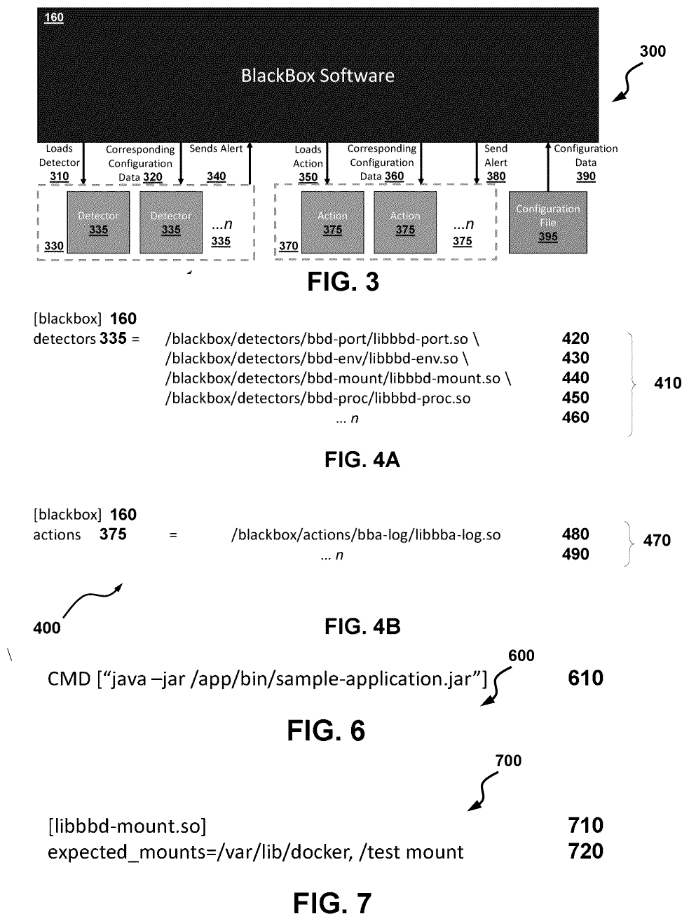

FIG. 3 shows a block diagram view 300 of an interactive configuration. BlackBox software 160 communicates by providing detector loader instructions 310 and detector configuration data 320 to a first series 330 of detectors 335 and receives an alert 340 from the series 330. The software 160 further provides action loader instructions 350 and action configuration data 360 to a second series 370 of actions 375, and then issues an alert 380. Configuration data 390 are supplied to the BlackBox software 160 via a configuration file 395.

The detectors 335 are built to execute once or on a continuous interval depending on what the particular detector 335 is monitoring. Container environments 150 operate with a specific lifecycle that permits certain events to be executed at certain points. Detectors 335 monitor environment variables, being mounted file systems and devices. These detectors 335 only execute once upon initiation of the container environment 150. This is due to initiation being the only time the monitored events can be changed in the container's lifecycle. Detectors 335 that monitor listening ports, operator changes, and an interactive terminal 140 do so continuously because these events can be executed at any stage in the container's lifecycle.

The configuration file 395 is in “ini” format. Each header is the name of the detector 335 being executed, and the content applying to that detector 335 will be assigned to the corresponding header. The main application “blackbox” 160 has an entry in the ini file that enables operators to specify the detectors 335 that they want loaded and executed.

This is accomplished by having their location in the container environment 150 as the values for the key “detectors” under the “blackbox” category. This provides flexibility for the developer to execute all the detectors 335 (recommended), only execute the highest priority detectors 335, or execute custom-built detectors 335. The detectors 335 listed are dynamically loaded and started when the BlackBox software 160 initializes. An example of the configuration in the ini file is provided in view 400.

FIGS. 4A and 4B show text instructional views 400 of an ini File Entry 410 for BlackBox software 160. FIG. 4A includes loading 410 the detectors 335 of the series 330. In the detector configuration as shown, these include portal (port) 420, environment (env) 430, mount (mount) 440, process (proc) 450, etc. 460 operations. The detector 335 considers the following instructions to be OS-provided mounts: /dev/sys/etc/proc, the last loading as proc 450. Entry for actions 375 for loading 360 the actions 375 of the series 370. FIG. 4B includes loading instructions that include logon (log) 480 and loop repetition 490.

The detectors 335 and the BlackBox software 160 are bundled into a container image that can be utilized by other applications. The application 170 that implements the image provides the configuration file 395 with permissible behaviors in the container environment 150 and adds the appropriate software as applications 170 to the BlackBox container image. Upon initialization of the container 150, the BlackBox software 160 reads the provided configuration file 395 and executes the detectors 335 that start monitoring events within the container 150.

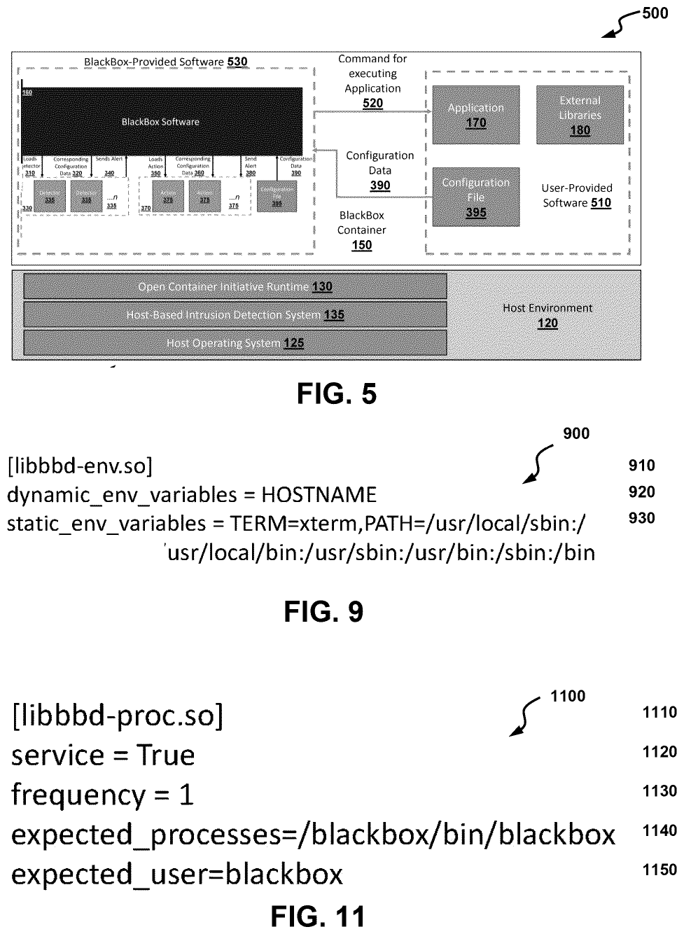

FIG. 5 shows a block diagram integrated view 500 of the BlackBox container 150 that includes user-provided software 510, commands 520 for executing an application 170 and the BlackBox provided software 530. The user software 510 includes the applications 170, support libraries 180 and the configuration file 395. The BlackBox provided software 530 includes components from view 300 and receives commands 520 from the applications 170 and expected container behavior from the configuration file 395 via configuration data 390. The host environment 120 also provides runtime 130, HIDS 135 and host OS 125.

FIG. 6 shows a text instructional view 600 for user-provided software application inside a Dockerfile. This includes a command (CMD) line to execute java-jar via a benchmark sample application as an example for specifying child processes. The entry point to the container environment 150 is a command line interface (CLI) to the BlackBox software 160. Arguments are entered in the “CMD” function 610 of the container 150. The BlackBox software 160 initializes the detectors 335 and then starts the arguments passed in via the “CMD” function as child processes of BlackBox software 160. Similarly, FIG. 7 shows a text instructional view 700 with a mount application 710 to execute test mount 720.

This ensures that the BlackBox software 160 is executed as a first Process ID (PID-1) inside the container environment 150 while nonetheless permitting other commands to be executed as child processes. When the child processes complete, the BlackBox software 160 receives the signal, and the software stops the detectors 335 and exits gracefully. This design enables the container environment 150 to have one parent process PID-1 while ensuring that the detection software still operates while the user-defined commands are executed.

The purpose of the mount detector 440 is to detect unexpected file systems being attached to the container environment 150. This can indicate someone's attempt to change or alter the contents of the container 150. For example, someone can mount a different application inside the container 150 and alter the expected behavior. The mount detector 440 is executed at startup of the container 150, and stops executing once processing is complete. The mount detector 440 has the following configurable variable: expected_mounts.

A comma-separated list of mounts can be configured via regular expressions. The detector 335 reads a list of expected mounts being provided when instantiating the detector 335. The expected mounts are read as regular expressions and used to check for matches against the mounts that stored in the container 150. The detector 335 then reads the contents of the /proc/mounts 450 file and checks each entry to determine whether the file matches any of the regular expressions or an OS provided mount.

In the event the mount does not find a match, the mount is deemed unexpected so as to generate an alert 340, and processing through the mounts continues. Otherwise when the mount matches either the expected mounts or OS provided mounts, then processing through the mounts continues. The detector 335 halts once process completion of all entries in the /proc/mounts 450 file.

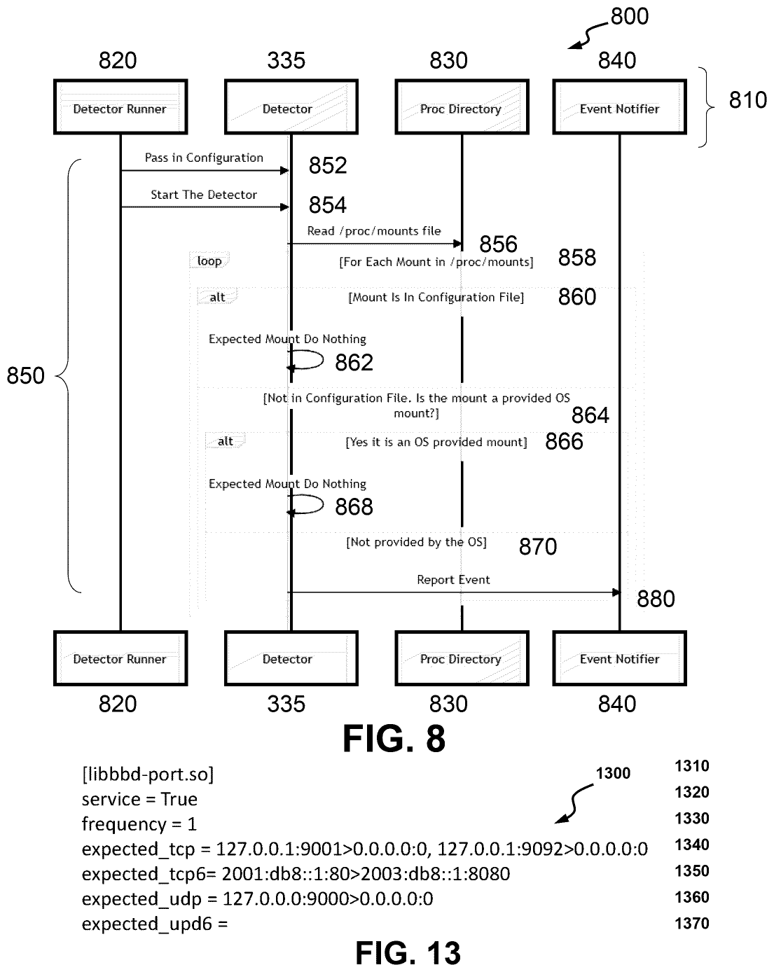

FIG. 8 shows a logic flow diagram view 800 of mount detector 440 representation for OS-provided mounts: /dev/sys/etc/proc as a chronological process. The mounts include operators 810 that include detector runner 820, detector 335, process directory 830 and event notifier 840 with sequential operations 850. The runner 820 communicates to the detector 335 a pass-in configuration 852 with configuration file 320 and detector start 854. The detector 335 issues read /proc/mounts file 856 to the process directory 830.

A loop 858 examines each mount in /proc/mounts as to whether belonging 860 in the configuration file 395. Meantime the detector 335 cycles 862 the expected mount in idle. If not in the configuration file 395, the detector 335 determines 864 whether the mount is OS-provided 866. If so, the expected mount cycles 868 in idle. For each such mount, the loop 868 repeats or alternatively 866 is retrieved from the configuration file 395. An OS-provided mount 866 presents an alternative, whereas non-provision by the OS 870 (analogous to OS 125) yields to reporting an event 880 to the notifier 840.

The purpose of the environment detector 430 is to detect changes in the environment that alters the behavior of the application 170 within the container 150. For example, assuming that the internet protocol (IP) address differs from what the Blackbox software 160 expects, the application 170 fails, or information is sent to an unexpected location. At container startup, the environment detector 430 is executed, and stops executing upon process completion. The environment detector 430 has the following configurable values: dynamic_env_variables.

FIG. 9 shows a text instructional view 900 with an environment variables application 910 to set dynamic_env_variables 920 to HOSTNAME, and static_env_variables 930 as TERM. Comma-separated lists of keys are expected to be set, such as for environment variables (e.g., HOSTNAME, HOME, etc.) and value pairs (e.g., PATH=/usr/bin, etc . . . ). The key can be configured using regular expressions such as static_env_variables.

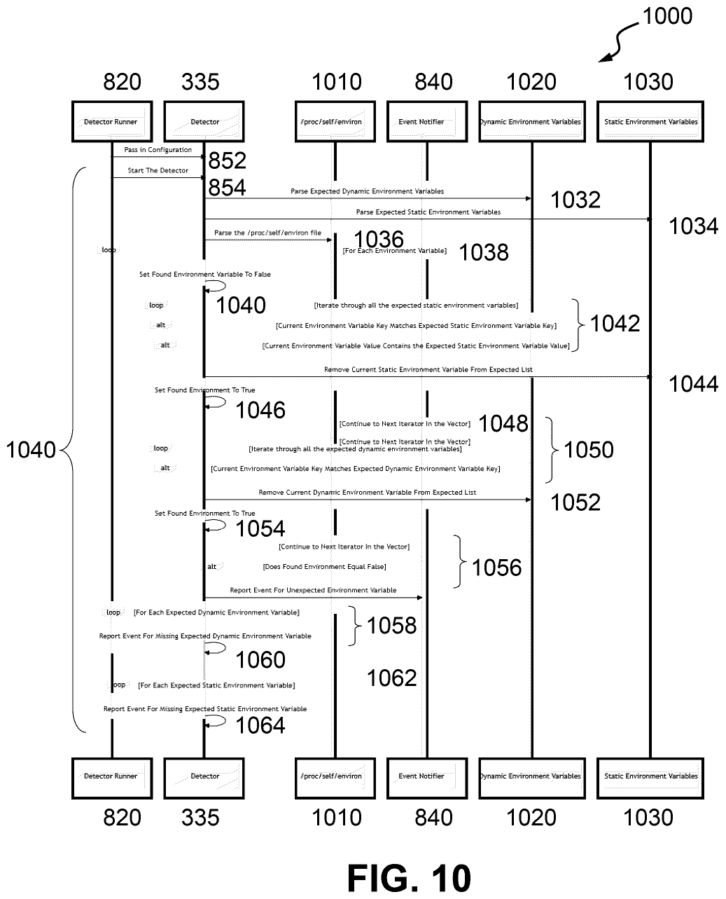

FIG. 10 shows a logic flow diagram view 1000 of the environment detector 430 in graphical representation. The operators include detector runner 820, detector 335, process self environ 1010, event notifier 840, dynamic environment variables 1020 and static environment variables 1030 with sequential operations 1040. The runner 820 communicates to the detector 335 a pass-in configuration 852 with the configuration file 320 and detector start 854. The detector 335 parses 1032, 1034 and 1036 expected dynamic variables 1020, static variables 1030 and environ 1010 for each variable 1038 and set to false. The detector 335 then parses the proc/self/environ loop 1040 for each dynamic variable. Additional loops set the found environment variable to false or true, report event for missing environment variables, dynamic or static.

For the first loop 1040, an operation 1042 operation iterates expected static variables 1030, matches environment keys and sets the variable value 1044 to true and removes current environment variable from the list. For the second loop 1046, an operation 1048 continues and iterates dynamic variables and matches keys 1050. The conclusion 1052 removes the dynamic environment variable 1020 from the expected list. For the third loop 1054, an operation 1056 continues and iterates dynamic environment variables 1020 for reported events 840. Subsequent loops 1058 iterate for missing expected environment variables: dynamic 1060 and static 1062 to report events 840 for missing variables in loop 1064.

The detector 335 reads a list of expected static and dynamic variables that are provided when instantiating the detector 335. The static and dynamic environment variables are read to validate against the environment variables currently in the container 150. The detector 335 reads the environment variables in the /proc/self/environ file and loops through each entry 1042. The detector 335 loops through each dynamic environment variable to determine whether a match exists in the expected dynamic keys.

When no match is found, the detector 335 continues; whereas when there a match is found, the variable is erased in value 1044 from the expected dynamic environment variables list. Once the dynamic variables are cycled through, the detectors 335 loop through all the static environment variables 1048 to determine whether a key value match 1050 can be found. In the alternative of a match 1050, the variable is erased 1052 from the expected static environment variables list. The absence of a match after cycling through the dynamic and static variables in loop 1054 generates an alert 380 for the unexpected environment variable.

At the end of the detector's lifecycle, an alert 380 is also generated for every expected environment variable that was not removed, enabling the container 150 to report to the notifier 840 an event 880 of not finding an expected variable. FIG. 11 shows a text instructional view 1100 for a libbbd process 1110 with true label 1120 and set frequency 1130. These include expected BlackBox processes 1140 and expected user 1150.

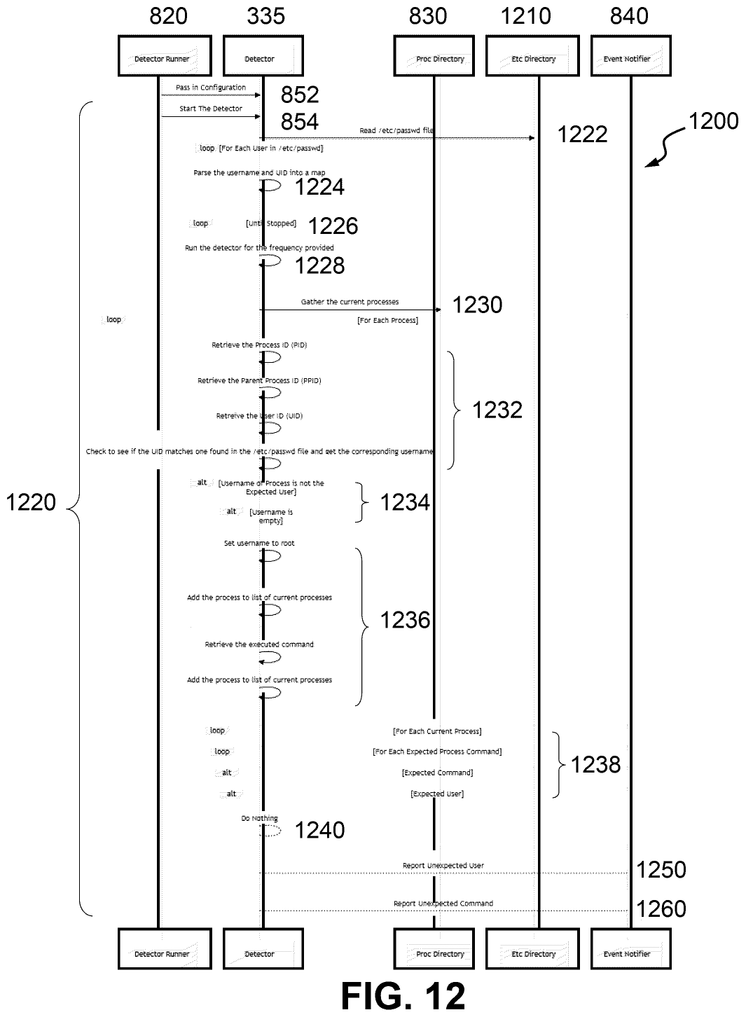

FIG. 12 shows a logic flow diagram view 1200 of graphical representation for the process detector 450. The operators include detector runner 820, detector 335, process director 830, etc directory 1210 and event notifier 840 with sequential operations 1220. The runner 820 communicates to the detector 335 a pass-in configuration 852 of the configuration file 320 and detector start 854 for the detector 335. This detector 335 reads /etc/passwd file 1222 from the etc directory 1210. A loop 1224 for each such operator then parses the username and identification to a map. A loop 1226 then runs the detector 335 for the provided frequency 1228, followed by gathering 1230 of the current processes at the process directory 830.

Within gathering 1232 and for each current process, loops 1232 operate to respectively retrieve the process identification (PID), parent process identification (PPID) and the user identification (UID). A verification query of UID match 1234 found in the /etc/passwd file 1222 can yield results of username not being expected or username being empty, followed by setting username to root. Additional loops 1236 respectively add the process to the current process list, retrieve the executed command and add the process to the aforementioned list. A further set of loops 1238 for each current process and expected processes provide for expected command and expected operator followed by a pause 1240. Upon identifying an unexpected circumstance, a report to the notifier 840 indicates an unexpected operator 1250 and/or an unexpected command 1260.

On setup, the detector 335 reads the contents of the /etc/passwd file 1222 to determine the usernames and user IDs (UIDs) that are configured inside the container 150. This is conducted once for the container's lifecycle. The detector 335 then performs the following logic for every restart of the detector 335 that was defined in the configuration file 395.

All the processes that are currently executing are parsed for their identifications: parent id, process id, and user id (UID). The user_id is mapped to the usernames 1224 and UIDs that were parsed at the setup of the detector 335 to determine the username associated to the process. If the username is not the expected operator, and the username is not found in the /etc/passwd list 1232, that parameter is set to the default username of “root” 1234. Otherwise, the username is set to the operator found in the /etc/passwd list 1232.

Because the process is being executed by an unexpected operator, the detector 335 cannot parse the exec command 1236 associated with that process, so the process is set to null. If the username corresponds to the authorized operator, the exec command is parsed and added to the parent id, process id, and username. Each of the parsed processes is interrogated 1238 to determine whether or not the exec command associated with the process is expected. An alert 380 is being executed by an unauthorized operator 1250 or is generated in the circumstance this is not an expected process 1260.

The purpose of the port detectors 420 is to monitor ports inside the container 150 that are listening for network traffic to confirm the ports are expected, and a program is not opening new unexpected ports. An unexpected port may indicate an application sending or receiving unauthorized data. This might be caused by an application 170 being added to the container 150 to send information somewhere else. The port detector 420 is executed at startup of the container 150, and once processing is complete, executes again after the specified wait time 954. FIG. 13 shows a text instructional view 1300 for a libbbd port 1310 with service set to true 1320 and set frequency 1330. These lines include expected top 1340, 1350 and udp 1360, 1370 parameters.

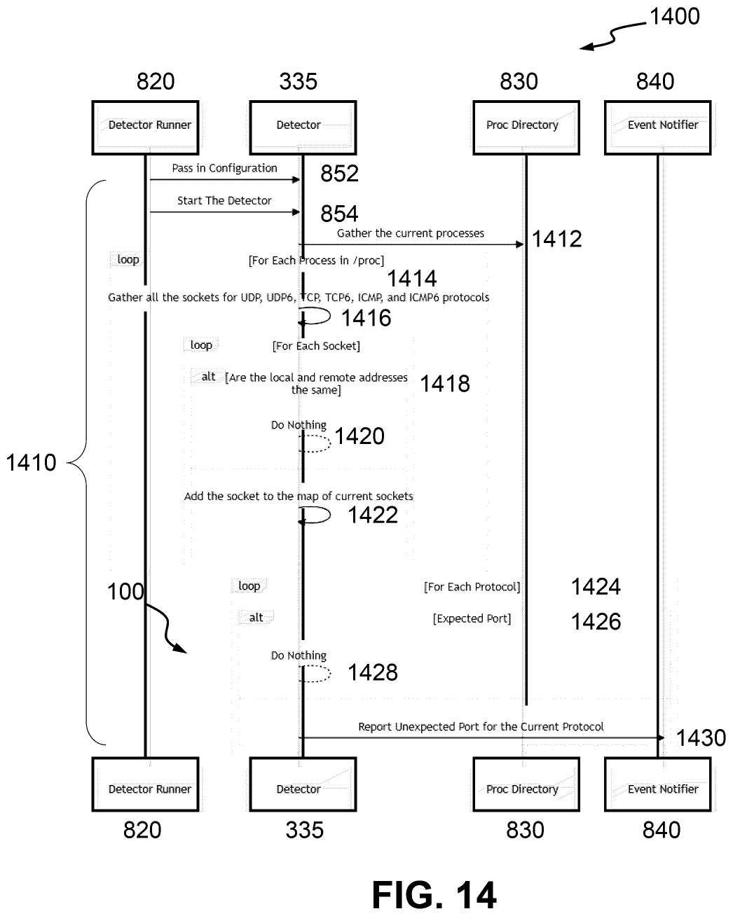

FIG. 14 shows a logic flow diagram view 1400 for the port detector 420. The operators include detector runner 820, detector 335, process director 830, and event notifier 840. The runner 820 communicates to the detector 335 a pass-in configuration 852 for configuration data 320 and detector start 854. The detector 335 gathers current processes 1412 and loops 1414 gathering sockets 1416 for each processor in /proc all port sockets for UDP, UDP6, TCP, TCP6, ICMP and ICMP6 protocols. Another loop 1418 for each socket determines whether the local and remote addresses are identical. This results in a pause 1420 and an addition 1422 of the socket to the socket map. An alternate loop 1424 for each protocol provides an expected port 1246, followed by a pause 1428. For an unexpected port, a report 1430 is issued to the notifier 840.

The purpose of the process detector 450 is to monitor every process started in the container 150 to ensure its execution by an authorized operator and is an expected command. An unexpected operator can be an indication that user escalation has occurred enabling an operator with excess permissions inside the container 150. An unexpected process could result from someone executing /bin/bash from an interactive terminal 140 against the container 150 and trying to traverse the contents. The process detector 450 is executed at startup of the container 150. Once processing is complete, the process detector 450 executes again after the specified waiting period.

The process detector 450 has the following configurable values: frequency, expected_processes and expected_user. For frequency, quantity relates to the number of seconds to wait between each execution of the detector 335. Expected processes involve comma-separated list of expected commands (e.g. /blackbox/bin/blackbox-cli). Expected user involves the username of the expected operator to be executing processes inside the container 150. This username must be in the /etc/passwd file.

The port detector 420 has the following configurable values in sockets 1416: frequency, expected_tcp, expected_tcp6, expected_udp, expected_udp6, expected_icmp and expected_icmp6. For the frequency value, quantity relates to the number of seconds to wait between each execution of the detector 335. Expected TCP involves comma-separated list of expected local addresses and remote addresses for TCP ports. Expected TCP6 involves common-separated list of expected local addresses and remote addresses for TCP ports.

Expected UDP involves comma-separated list of expected local addresses and remote addresses for UDP ports. Expected UDP6 involves comma-separated list of expected local addresses and remote addresses for UDP6 ports. Expected ICMP involves comma-separated list of expected local addresses and remote addresses for ICMP ports. Expected ICMP6 involves comma-separated list of expected local addresses and remote addresses for UDP6 ports. Expected ICMP involves comma-separated list of expected local addresses and remote addresses for ICMP6 ports.

The port detector 420 reads in the expected ports for each protocol and parses the expected addresses into local and remote addresses to be used for validation. The detector 335 gathers all the current processes to iterate over. For each process, all the sockets are gathered and evaluated to determine whether they are callback sockets or external sockets. This is accomplished by verifying that the local and remote addresses are equal. When equivalent, the port detector 420 does nothing. Otherwise, the addresses are different, the socket is added to the map of current sockets.

Once all the processes are iterated through, the detector iterates over each protocol that was added to the map of current sockets. For each socket, the local address and remote address are assessed to determine whether they match the expected corresponding protocol addresses. Assuming they match, the port detector does nothing; if they do not match, an alert 380 is generated reporting that an unexpected port for the current protocol was detected.

To leverage the Zero Trust methodologies, the default behavior of the software 160 is to report everything unexpected that happens inside the container 150. This ensures that the software 160 that is being deployed is not being tampered with when running. The developer of the container 150 provides the file of trusted behaviors within the container 150 to ensure unexpected behaviors are the only ones being reported.

The BlackBox software 160 was developed to monitor specific events 880 within a container 150, which leads to a lighter weight HIDS 230. The IDSs that currently exist are all executed on the host system and not inside the container 150 like the BlackBox software 160. This enables the developer to control the expected behavior of deployed containers 150 and not rely on the deployed platform to ensure the behavior of the container 150.

With the protections in place, this increases the assurance that what was developed is performing as expected when in a deployment environment. While there are still ways to copy the software 160 out of the container environment 150, these protections in place render that task much more difficult. Utilizing existing technologies like signing the images and HIDSs 135 and 230 in conjunction with the BlackBox software 160 increases the cyber security posture of the deployed system.

BlackBox software 160 was developed to be a minimal, modularHIDS 230. BlackBox software 160 implements Zero Trust strategies inside the container environment 150 to ensure the software being deployed operates as intended without interference. This implementation does not fully protect the contents of the container environment 150, because an operator can still extract the contents at rest, but the protocol implements assurance tools to regulate the expected behavior of the container environment 150 while running.

The BlackBox software 160 utilizes an external open-source library called “pfs” (https://github.com/dtrugman/pfs) used to parse the system files that are added to the container 150 when initiated. This exemplary software 160 facilitate parsing process related information in the detectors 335, but the code itself is merely a utility that gets called by the detectors 335 and does not accomplish the detection itself.

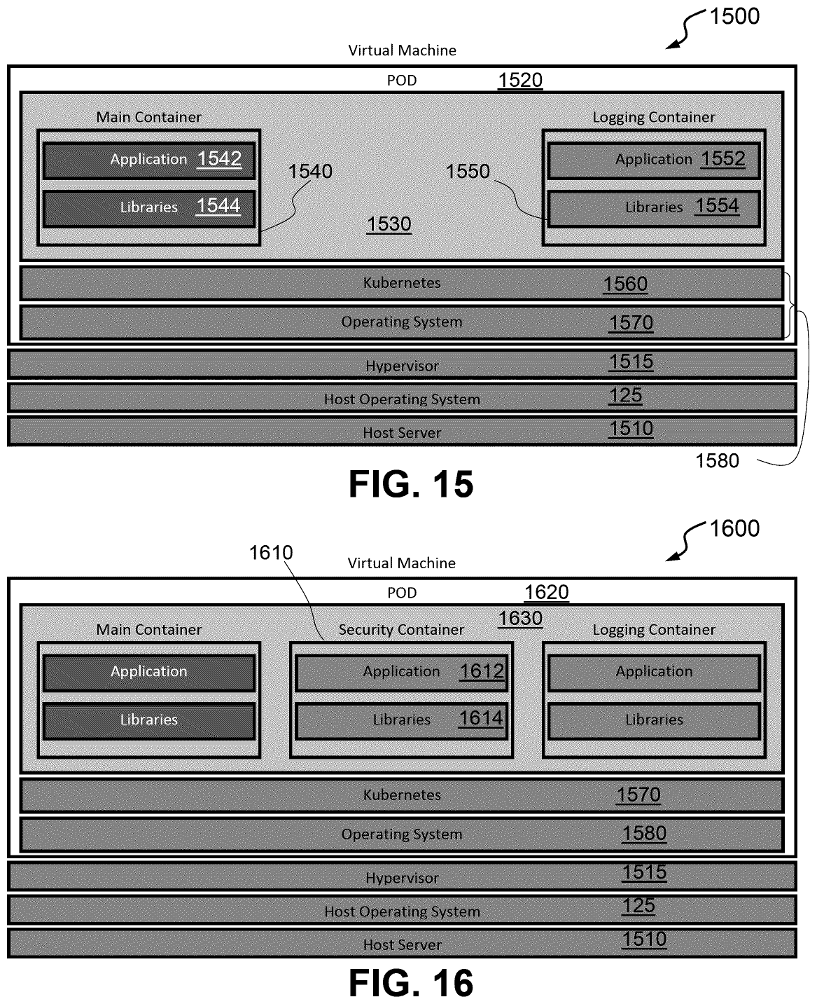

FIG. 15 shows a block diagram view 1500 of a host with a server 1510, operating system 125 and hypervisor 1515. A virtual machine 1520 with a pod 1530, which includes main container 1540 with application 1542 and libraries 1544 along with a logging container 1550 with application 1552 and libraries 1554. Kubernetes 1560 and operating system 1570 form a stack 1580 that are also included in the virtual machine 1520.

The container software package includes all features required to execute piece of software—application, runtime, libraries, settings. The goal of a container is to be portable and stood up with little to no intervention on host platform. A container is always “alive” as long as PID 1 is executing inside the namespace.

Typical Kubernetes 1560 deployment has an operator's main container 1540 and a logging container 1550 as a sidecar. The main container 1540 is the only part of the deployment that the operator develops. The pod 1520 and the infrastructure stack 1580 below the container are not secured.

FIG. 16 shows a block diagram view 1600 of the host with a virtual machine 1620 with a pod 1630. In addition to the main container 1540 and logging container 1550, the pod 1630 further includes a security container 1610 with application 1612 and libraries 1614. An operator can attach the security container 1610 as a sidecar container in the pod 1630 that will assist to monitor events 880 within container namespace. That benefits with monitoring within the pod 1630, but the infrastructure stack 1580 below the pod 1630 remains unsecured.

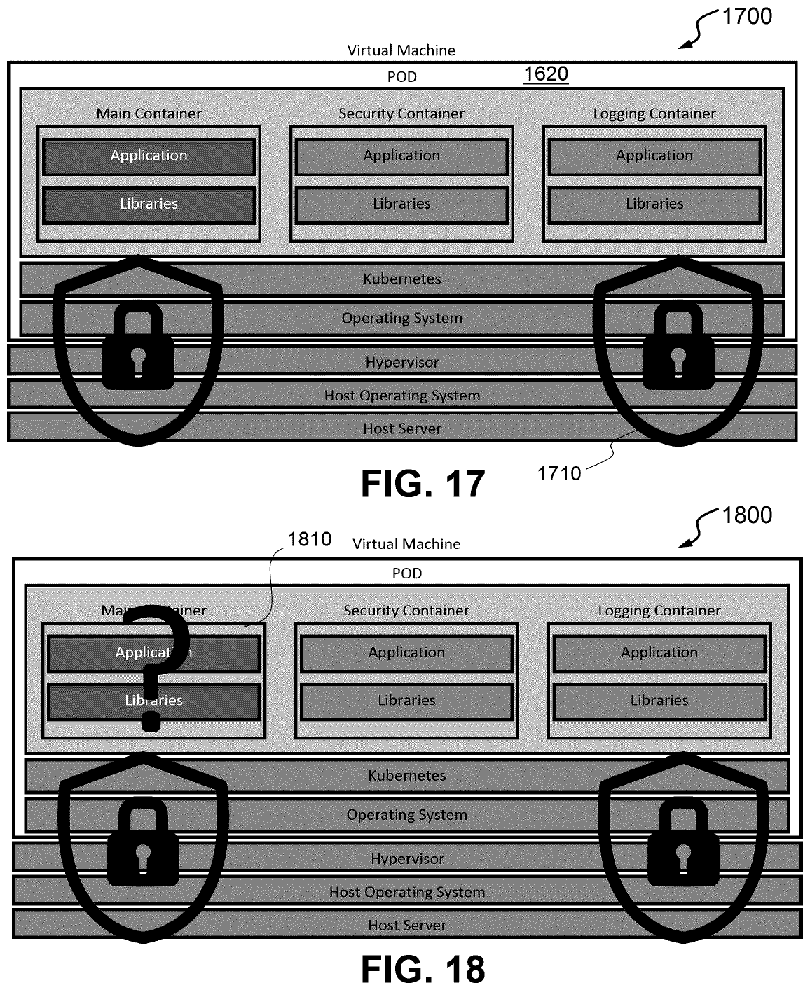

FIG. 17 shows a block diagram view 1700 of the host and virtual machine 1620 under lockout 1710. An operator can secure the infrastructure by utilizing a Host-Based Intrusion System (HBIS) 230, implementing role based access controls in Kubernetes 1560, and restricting system calls in the virtual machine operating system 1570. FIG. 18 shows a block diagram view 1800 of under lockout 1710 with security of the main container 1540 uncertain 1810.

Everything else in the stack 1580 has some sort of mechanism to ensure applications operate as intended, but what about the main container 1540 that has the application that the operator has developed? Lack of assurance causes uncertainty 1810.

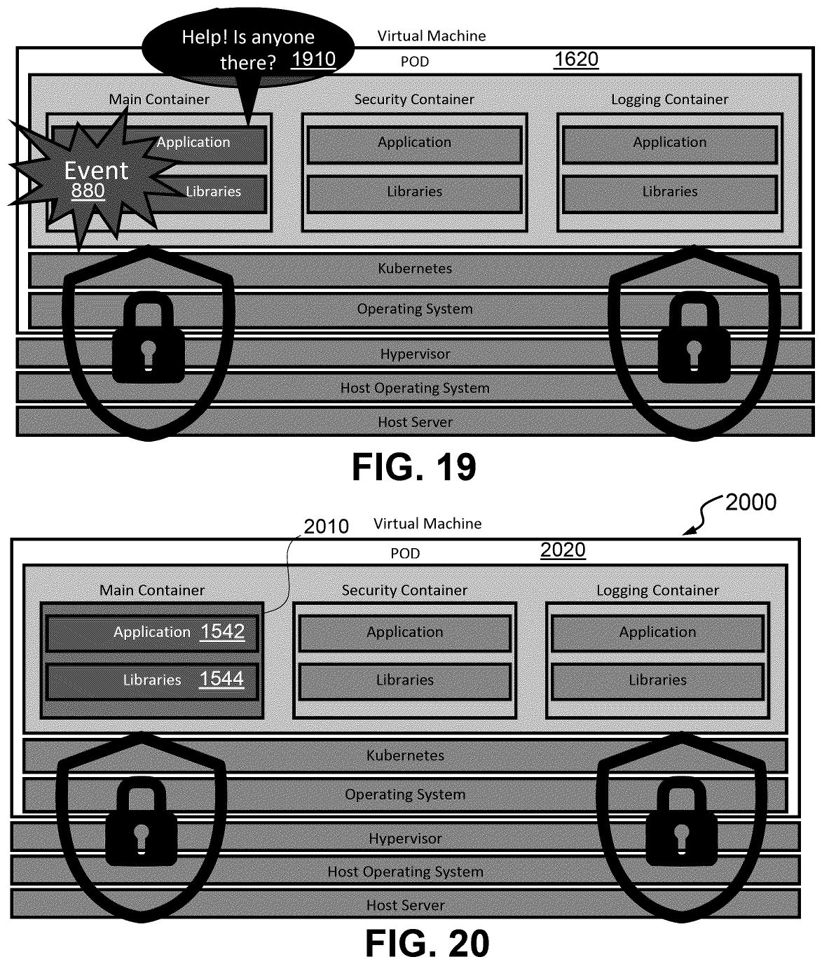

FIG. 19 shows a block diagram view 1900 of the host and virtual machine 1620, with an event 880 triggering an alarm 1910 from the application 1542. Sidecar containers have their own lifecycle so they can start and stop at any point as long as the main container 1540 continues executing. An example would be the security sidecar container 1610 had crashed for some reason with attendant effect to deployment.

FIG. 20 shows a block diagram view 2000 of a main container 2010 within the virtual machine 2020 in which the main container 2010 has replaced the security container 1610 for maintaining security within the pod 2020. The main container 2010 can encounter an issue or event 880 and the security container 1610 has failed in detection of that event 880. Deployment of Kubernetes 1560 yields the only control as belonging to the main container 2010.

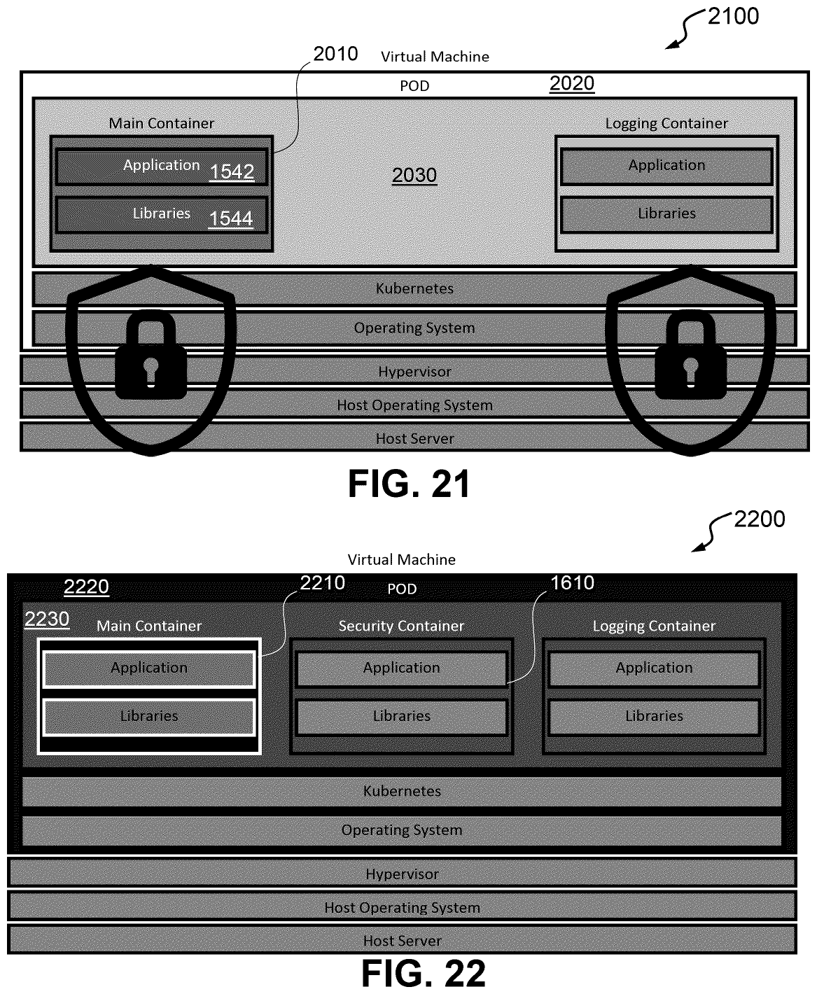

FIG. 21 shows a block diagram view 2100 of the main container 2110 within the virtual machine 2020 operating in the pod 2030 absent the security container 1610 as being effectively disabled from lack of reliable control. This restriction of control to the main container 2010, the operator lacks control of the HBIS 230, role based access controls, and restrictions of system calls at the level of the virtual machine 2020.

FIG. 22 shows a block diagram view 2200 of a main container 2210 within the virtual machine 2220 operating in the pod 2230 together with the security container 1610 under non-secure circumstances. This is analogous to view 2000 with the main container 2010 operating in the pod 2030. This leads to query of how to ensure that the main container 2210 is running as expected and not rely on the host 110 to provide that assurance.

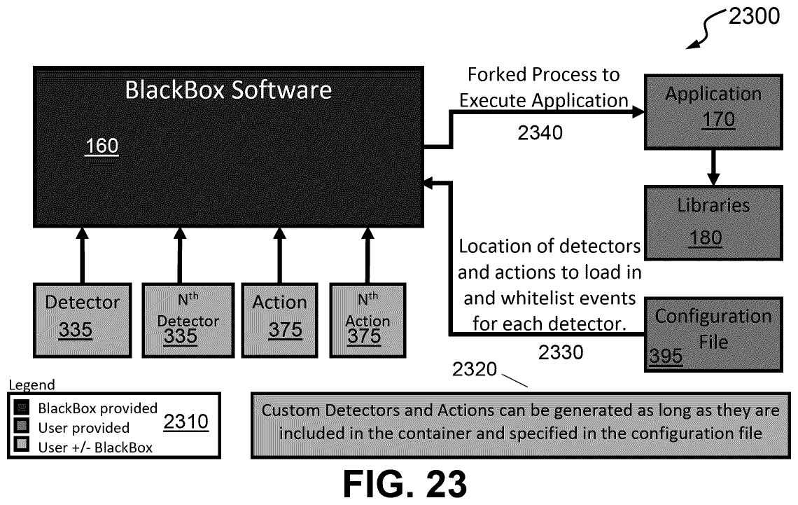

FIG. 23 shows a block diagram view 2300 of BlackBox software 160. A legend 2310 identifies components, and an annotation 2320 provides context. The software 160 receives inputs from the detectors 335, actions 375 and configuration file 395 via location and load information 2330, and submits outputs via forked process 2340 to an application 170 connected to libraries 180. This enables foregoing reliance on the host 110 to provide the assurance for the container, the host treats the main container 2210 via a BlackBox 160.

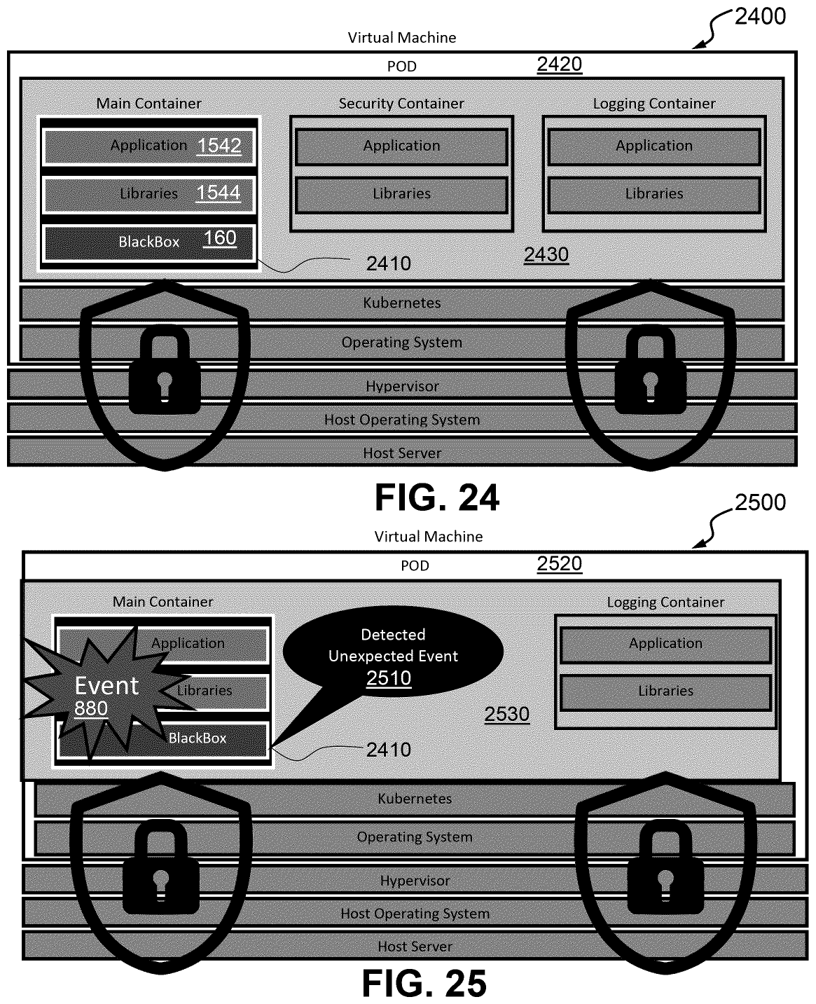

FIG. 24 shows a block diagram view 2400 of a main container 2410 having the BlackBox 160. The virtual machine 2420 operates the main container 2410 within the display 2430. In the end, everything on the host 110 becomes a BlackBox 160 to the main container 2410. This means the operator cannot rely on the services provided by the host server 1510 to provide assurance that the main container 2410 is executing as expected.

Within this strategy, one can implement Zero Trust methodologies within executing main container 2410. This provides a framework for custom detectors and actions to be loaded and configured. The configuration file 395 contains “white listed” events 880 that are expected inside the main container 2410 and are hosted therein. This enables a developer to recognize the environment 220 for deployment during development. The virtual machine 2420 hosts the main application 2410, within which BlackBox 160 runs as PID 1 and creates a fork that runs application 1542.

In view 2400, BlackBox 160 is included in the Main Container 2410. This includes the detectors 335, actions 375, and configuration file 395. This gives the intra container security to complement the inter-container security provided by the host system 110. Now lets revisit the example earlier about the sidecar stopped executing and there was an issue with the main container 2410, but this time with intra container protections. BlackBox software 160 would have a detector 335 that found an unexpected event 880 within the container and would generate an alert 370 to propagate to the actions 375. This enables the system to have more redundancy through security in depth.

FIG. 25 shows a block diagram view 2500 of the main container 2410 subject to the event 880 and the BlackBox 160 responding with a detection 2510 such as alert 380. This occurs within the virtual machine 2520 operating the pod 2530 that includes the main container 2410 and logging container 1550. BlackBox 160 provides the ability to have a custom set of detectors 335 and actions 375. All information is driven by the configuration file 395 including the behavior of the detectors 335.

Returning to FIGS. 3 and 4 provides further clarification. Defined interface that enables software to be loaded and execute: (a) one time only, (b) as a service that restarts with frequency specified—Configuration file has metadata that drives the behavior of the detector “ini” file format/example metadata: service or one time only, frequency of restart whether a service, detector specific key values—Capability of producing events 880 with varying severity levels that BlackBox framework 160 propagates to actions 375.

Mount detector: ensures mounts accessible to container 150 are those expected—Environment Detector: ensures that the environment variables are those expected—Process Detector: ensures that each process is an expected command and executed by an expected operator—Port Detector: ensures that the ports listening within the container 150 are expected.

Defined interface that enables software to be loaded and called whenever an event 880 is generated. Such an event 880 comprises of severity, timestamp and description. Every action 375 gets all the events 880, and it's up to the action 375 to determine whether the event 880 is something that will perform an action 375.

An action 375 can take on varying forms like logging, health and status, and/or counter measures. This can be anything that one's organization wants to accomplish upon being alerted 1910 to an event 880. One could publish the event 880 to a health and status monitoring tool like Prometheus so that one can offload the event 880 for analysis later on. One could also have an action 375 that snapshots the state of the container 150 to be replicated again at a later date.

The life cycle of BlackBox follows the container life cycle with the host 110 initiating the container 150. Instead of the main application 2410 starting, one can to start BlackBox framework 160 as PID 1. Then the container 150 is going to load and start the detectors 335 that are specified within the configuration file 395.

Blackbox software 160 will then fork PID 1 and launch the main application 1542 specified by the operator as a child process. Any detectors 335 that are executing as services, are running whenever the child process if executing. Once the child process completes, BlackBox 160 exits and the container 2410 ceases executing.

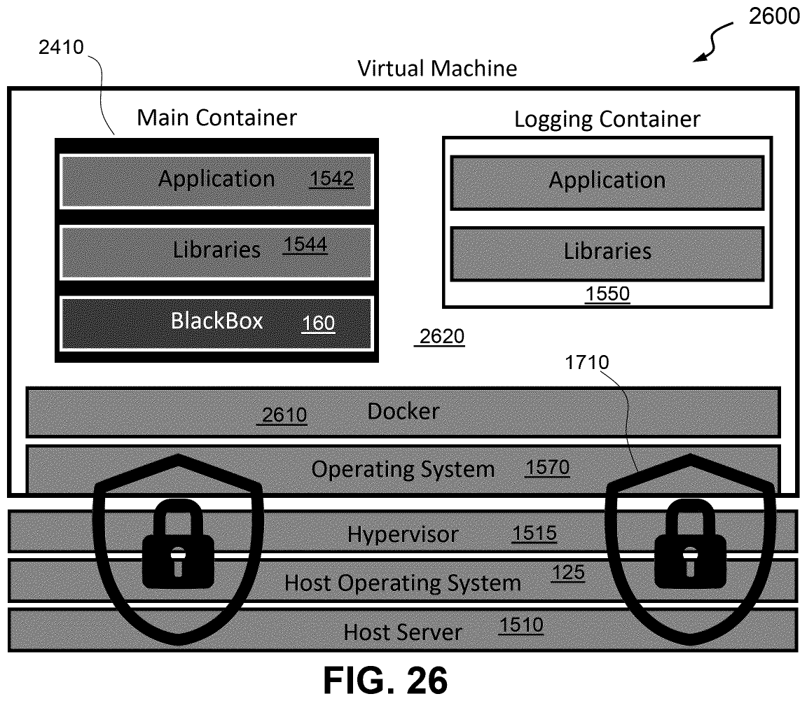

FIG. 26 shows a block diagram view 2600 of the main container 2410, together with Docker 2610 and operating system 1570 within the virtual machine 2620. Sometimes one might have a system that has a smaller infrastructure footprint, one would use Docker 2610 or Podman. One wouldn't have any additional Role Based Access Controls and each container would be in their own namespaces, so one loses the concept of a sidecar to provide an operator that security. One can implement BlackBox 160 as container so that there is still the same level of intra container assurance as there would be on an enterprise level software stack as Kubernetes 1560. This can enable security in depth and complement other security methodologies. Exemplary embodiments provide lightweight and configurable software and provides a developer the means to ensure that product they built is executing as expected.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented operation method for isolating a software application from operating system software, said method comprising:
installing a configuration file that enables interaction with the application;
installing a plurality of detectors for analyzing input to the application, said input as one of either belonging to an authorization list and being absent therefrom; and
installing a monitoring software program; and
executing said monitoring software program to load said plurality of detectors, receive application information from said configuration file, and activate an alert in response to said input being absent from said authorization list.

2. The method according to claim 1, wherein said monitoring software program communicates with an application support library.

3. The method according to claim 1, wherein said monitoring software program communicates with custom software.

4. The method according to claim 1, wherein said authorization list includes mount, environment and process parameters.

5. The method according to claim 1, wherein said authorization list includes at least one of user identification, process identification and parent process identification.
